(19) United States
(12) Patent Application Publication
(10) Pub. No.: US 2024/0412096 A1
(43) Pub. Date: Dec. 12, 2024

(54) AUTOMATIC ML PIPELINE PLANNING FOR LIVE ML ANALYTICS

(71) Applicant: Microsoft Technology Licensing, LLC, Redmond, WA (US)

(72) Inventors: Anand PADMANABHA IYER, Redmond, WA (US); Ganesh ANANTHANARAYANAN, Sammamish, WA (US); Yiwen ZHANG, Ann Arbor, MI (US)

(21) Appl. No.: 18/208,173

(22) Filed: Jun. 9, 2023

(51) Int. Cl. G06N 20/00

(52) U.S. Cl. CPC G06N 20/00

(57) ABSTRACT

Optimizing ML pipeline deployment using an ML pipeline management system. A method includes receiving an indication of an input data source and input data type from the input data source. An indication of a plurality filters to be included in the pipeline, an ML model, and predetermined performance criteria is received. The method includes determining a physical topology of the ML pipeline and configuration of the filters or the ML model. The determined physical topology includes placement of the filters and the model, and the configuration. The determined physical topology satisfies the performance criteria. The filters and ML model are placed across an infrastructure, comprising a plurality of tiers, according to the determined physical topology.

### BACKGROUND

### Background and Relevant Art

Recent years have witnessed a growing demand for machine learning (ML) analytics. ML analytics may include applications in live traffic analysis, real-time speech recognition, infrastructure-assisted autonomous driving, etc. ML analytics involves ML pipelines at its core, where each pipeline includes operators to perform specific ML tasks. For example, a typical traffic analysis pipeline may contain filtering modules, such as a color filter, along with a deep neural network (DNN) object detector model, where the filters are used to reduce storage, network, and/or compute consumption at different stages of the pipeline.

Large scale ML analytics is characterized by at least two unique aspects. First, these ML pipelines are deployed across heterogeneous edge infrastructures, spanning multiple tiers such as device edges, on-premise edges, public multi-access edge compute (MEC), and cloud datacenters. Second, they often have stringent latency requirements as the analytics are based on real-time data, and often require corresponding quick reactions.

When production ML pipelines are deployed in heterogeneous environments, they are often first constructed manually or taken from a prior deployment, and then placed across the edge infrastructure based on past deployment experience, before configuration for currently needed functionality is applied. However, this often results in sub-optimal deployments and requires an inordinate amount of manual trial and error deploying.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method that may be practiced At an ML pipeline management system. The method includes acts for deployment of an ML pipeline, wherein the ML pipeline includes operators to perform specific ML tasks. The method includes receiving an indication of an input data source, and input data type from the input data source. An indication of a plurality filters to be included in the pipeline, an ML model, and predetermined performance criteria identifying resource consumption limits are received. The plurality of filters include filter operators that operate on input data from the input data source to reduce input data size by sampling data or filtering out data. The method includes determining a physical topology of the ML pipeline and configuration that satisfies the performance criteria. This is done using a plurality of configurations of operators in the operators as input. The physical topology includes physical placement of the filters and the ML model across an infrastructure and configuration. The filters and ML model are placed across the infrastructure according to the determined physical topology causing resources consumption of the ML pipeline to not exceed the computing resource consumption limits when the filters and the ML model are performing the specific ML tasks. Different tiers in the plurality of tiers are collections of computing resources. The different tiers have different geographic boundaries, different compute latencies, and different network throughputs from each other.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a machine learning pipeline management system constructing and deploying a machine learning pipeline to a heterogeneous edge infrastructure;

FIG. 2 illustrates a high level workflow in the context of a profiler and monitor implemented at the machine learning pipeline management system;

FIG. 3 illustrates an example machine learning pipeline;

FIG. 4 illustrates a specific example of a machine learning pipeline;

FIG. 5 illustrates a high level flow of evaluating machine learning pipeline placement choices;

FIG. 6 illustrates an example of determining latency in a machine learning pipeline across infrastructure tiers; and

FIG. 7 illustrates a method of a method of optimizing deployment of a ML pipeline, wherein the pipeline includes operators to perform specific ML tasks.

### DETAILED DESCRIPTION

Embodiments illustrated herein perform automatic ML pipeline planning, deployment and updating based on user-provided characteristics and performance requirements. Embodiments implement ML pipeline plans that optimize latency and accuracy performance, while minimizing storage, network, and/or compute resource consumption. Generating such ML pipeline plans and deployment, however, is challenging due to multiple reasons. First, there is no one-size-fits-all solution. Different pipelines lead to different performance characteristics based on user's performance preferences.

Second, placement and ML pipeline configuration decisions are considered jointly, inevitably leading to a much larger search space—this is because only considering ML pipeline configurations for a fixed placement or considering placement decisions for a fixed configuration leads to sub-optimal ML pipeline plans. However, profiling all possible placement decisions by deploying pipelines across various tiers is expensive. In particular, the so called edge comprises computing resources deployed at locations where data is user produced or user consumed. These resources are generally more costly due to inefficiencies, lower scale than cloud computing resources, and the implementation of task specific hardware and software. In contrast, cloud computing resources, which are implemented at a remote location from where users interact with computing resources, can be repurposed in efficient ways and can scale as needed.

Finally, ML pipeline performance is resource and data dependent. Considering all possible resource and data dynamics that may or may not happen in the future can further exaggerate the search for efficient deployments of ML pipelines. Clearly, a more efficient online adaptation technique is needed for faster convergence and lower profiling cost.

One embodiment illustrated herein includes an ML analytics system that performs automatic ML pipeline planning for ML pipelines. Given ML pipeline characteristics (such as data sources, data types, filters, and ML models), along with performance requirements on ML pipeline latency and accuracy, one embodiment generates the ML pipeline plan.

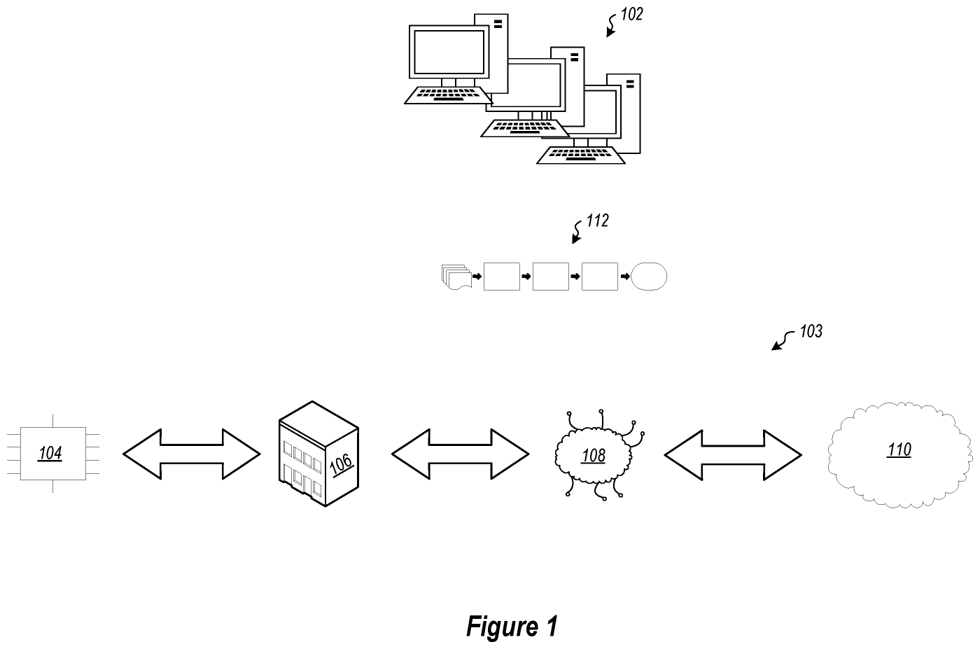

Referring now to FIG. 1, one embodiment first constructs an initial pipeline 112, at an ML pipeline management system 102, by mapping user ML pipeline specifications, as discussed in more detail below, to a general template optimized for performance and resource consumption efficiency. The ML pipeline management system 102 includes various hardware, such as processors and memory, and computer executable instructions to performe the functionality illustrated herein. The embodiment then determines an optimized ordering of operators (e.g., ordering of filters, ML models and potentially other specialized tasks) based on a metric to quantify the impact of filtering operators and/or ML models on ML pipeline latency and accuracy. The ML pipeline 112 can be deployed by an ML pipeline management system 102 across heterogeneous infrastructures, such as heterogeneous edge infrastructure 103, spanning multiple tiers, including for example, device edges, such as device edge 104, on-premise edges, such as on-premise edge 106, public multi-access edge compute (MEC), such as MEC 108, and cloud datacenters, such as cloud datacenter 110. A device edge tier comprises edge devices, which are hardware devices, that control data flow at the boundary between two networks. An on premise edge is a tier where certain compute devices, such as GPUs, and/or storage devices are implemented locally where data is input by users and output by users. A MEC tier is also a tier where certain compute devices, such as GPUs, and/or storage devices are implemented locally where data is input by users and output by users, but having more compute capacity and network throughput than an on premise edge. Additionally, the MEC tier connects to cloud data centers allowing certain compute and storage functions to be performed remotely at the cloud data centers. MECs are often implemented to address latency concerns and/or network traffic limitations. Processing and/or storage that requires lower latency and/or more reliability can be performed locally at the MEC tier, while other processing and/or storage can be performed at the cloud data centers. In this example, cloud data centers have even higher compute capacity and even higher network throughput than the other tiers illustrated in the example. Thus, in general, an infrastructure will have different tiers. The tiers have different geographic boundaries. For example, a device tier may have a boundary of a device. A building tier may have a boundary of a building, even though a device may reside in the building. The boundaries are nonetheless different. Different tiers have different compute latencies and different network throughput. Generally, two tiers will differ from each other by at least a factor 3 for compute latency and a factor of 5 for network latency. Less than this, and it is generally not sufficiently efficient (i.e., no performance improvement is obtained) to use different tiers.

Given the constructed pipeline 112, one embodiment efficiently explores placement by memoizing intermediate results for each pipeline operator, such that the performance of a new placement with the same ML pipeline configuration can be estimated without re-launching the pipeline. That is, as pipeline filters and/or ML models are placed at various locations, on various tiers, performance measures, such as accuracy, latency, and resource consumption, are memoized and reused rather than being remeasured. Note that as used herein, configuration refers to ML pipeline operator configuration. Thus, configuration refers to configuration of filters, ML models, and specialized tasks operators. Configuration refers to setting any configurable setting on one of these operators. Examples of such configurations may include setting hardware resource budges (i.e., specifying maximum network, compute, or memory resources available for a operator), configuring precision of filters, configuring recall of filters, configuring sample rates of filters, configuring resizing factors, configuring ML model parameters, etc.

For each placement choice, one embodiment explores the best set of configuration knobs of an ML pipeline by leveraging optimization algorithms, such as Bayesian Optimization algorithms, or other optimization algorithms. By encoding an ML pipeline's accuracy, latency, and resource consumption into a combined utility, one embodiment picks the configuration with the highest utility value in a small number of steps.

One embodiment performs online adaptation for deployed ML pipelines by performing reprofiling when runtime dynamics (such as changes in compute, network, and/or storage resources, changes in available filters, changes in available ML models, performance criteria changes, changes in input data, etc.) are detected and leveraging prior knowledge (such as memoized data) during reprofiling. Together, these lead to fast convergence speed with low profiling cost.

The user submits an ML pipeline specification into an ML pipeline management system 102 including information such as source of input data, data types from the source of input data, ML pipeline objectives (such as identifying objects of interest, recognizing language or other patterns, generating predictions, generating interactions, providing recommendations, detecting anomalies, summarizing data, etc.), filter(s) for data, the type of ML model(s) to use, and/or one or more performance characteristics. Note that in some embodiments, the user submitted ML pipeline specification may include different items than the example above based on the system being used.

Illustrating now one specific example of an ML pipeline specification to illustrate specific application of the general principles, an example ML pipeline specification may identify that input data is a 3D point cloud generated by on-vehicle LiDAR sensors. In this example, the task is to detect vehicles around the autonomous driving car using a 3D object detector including one or more ML models, which can be installed on edge compute devices.

Embodiments illustrated herein can use a utility function to facilitate pipeline placement and pipeline operator configuration. In particular, given a pipeline q with placement p and pipeline configurations c, U_{q,p,c}, the utility function of a ML pipeline plan, is defined, in some embodiments, as the ratio of the ML pipeline performance to resource consumption:

$${U}_{q , p , c} = {P}_{q , p , c} / {R}_{q , p , c} \qquad ( 1 )$$

such that the higher the utility value is, the better performance and cost savings the ML pipeline plan can provide. P_{q,p,c} combines the performance of ML pipeline accuracy (Q) and end-to-end latency (L) by calculating the reward (or penalty) by achieving acceptable (or unacceptable) performance based on a minimum accuracy target (Qm) and a maximum latency target (Lm):

$${P}_{q , p , c} ( Q , L ) = γ \cdot {α}_{Q} \cdot ( Q - {Q}_{m} ) + ( 1 - γ ) \cdot {α}_{L} \cdot ( {L}_{m} - L ) \qquad ( 2 )$$

where γ∈(0, 1). γ is specified by users to express their preference between accuracy and latency. R_{q,p,c} combines the compute and network resource consumption of the pipeline:

$${R}_{q , p , c} = {α}_{gpu} \cdot {R}_{gpu} + {α}_{net} \cdot {R}_{net} \qquad ( 3 )$$

In some embodiment, the consumption of the compute resource consumption is calculated as the portion of the GPU (and/or other processor) processing time to the ML pipeline time, although in other embodiments, other processing may be included, additionally or alternatively. In one embodiment, an assumption is made that the compute cost is dominated by GPU cost. In some embodiments, this can be particularly relevant when ML pipelines rely heavily on GPU-based deep neural network (DNN) models. However, in other embodiments, other compute resource performance and functionality may be included in the compute cost. Such compute costs may be those realized by various nodes and edge components.

The network resource consumption is calculated as the sum of the portion of the pipeline bandwidth out of the available network budget assigned to the pipeline on each network path when data traverse through the edge. The constants αQ, αL, αgpu, and αnet used in Eq 1 and Eq 3 are set by the operator to balance different scales of performance and resource consumption such that each component in the combined utility has an appropriate weight.

Note that while not shown in the above equations, the embodiments may also be configured to take into account storage costs, such as memory and/or persistent storage costs in the utility function.

Embodiments are configured to generate ML pipeline plans that construct, configure, and place the ML pipelines across the edge. Embodiments may be further configured to perform online adaptation on the ML pipeline after its deployment.

Automatic pipeline construction is useful because one-size-fits-all solutions do not actually work for all ML pipelines and different pipelines lead to different performance characteristics Further, considering ML pipeline configurations for a fixed placement or considering placement decisions for a fixed configuration leads to sub-optimal ML pipeline performance. Thus, embodiments herein can counter this with efficient, low-cost solutions to explore placement and configuration for a given pipeline. Note that addressing these issues leads to situations where fast online adaptation is useful.

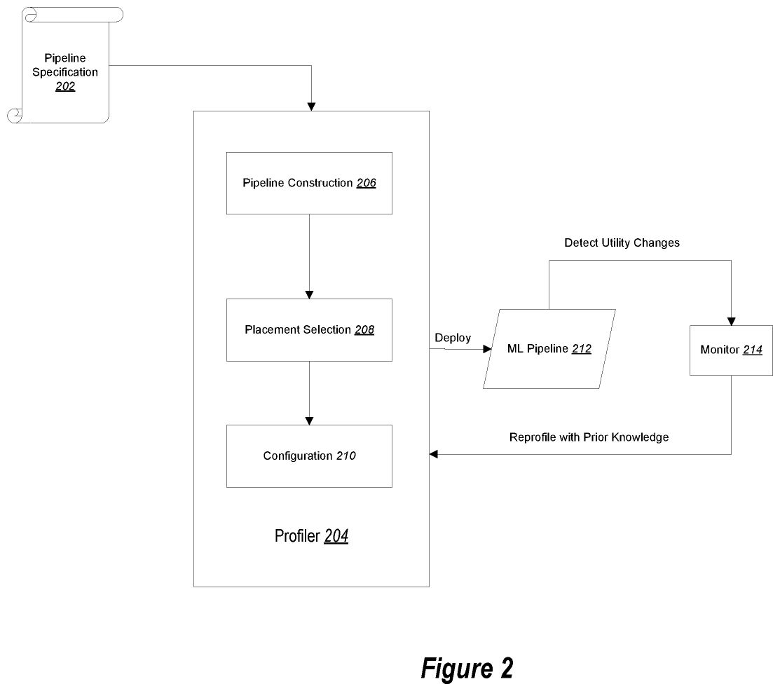

FIG. 2 presents a high-level workflow of one embodiment. A user launches a live ML analytics task by submitting an input ML pipeline specification 202 to the profiler 204, where the profiler 204 is implemented at the ML pipeline management system 102, and where the pipeline specification includes performance requirements. In some embodiments, this includes a minimum accuracy target (Qm), a maximum latency target (Lm), and a preference (γ) of the two. The following is an example of an ML pipeline specification.
Pipeline_Name=‘AD Perception’
Input_Source=‘on-board LiDAR’
Input_Data=‘LiDAR point cloud’
Object_of_Interests=‘all’
Filter=[‘gnd_removal’, ‘voxelization’]
ML_model=[‘PointPillars’]
max_Latency_ms=400
min_Accuracy_mAP=0.4
Preference_Acc_over_Lat=0.5

In this example, “Pipeline_Name” defines a unique name for the ML pipeline, “Input_Source” defines a source location for data input into the ML pipeline, “Input_Data” defines the type of data from the Input_Source, “Object_of_Interests” defines what objects of interest are to be identified by the ML pipeline, “Filter” defines a filter to be included in the ML pipeline, “ML_model” defines a particular ML model to be used in the ML pipeline, “max_Latency_ms” defines the maximum latency, in milliseconds, for the ML pipeline, “min_Accuracy_mAP” defines the minimum accuracy for the ML pipeline, and “Preference_Acc_over_Lat” defines an accuracy/latency ratio.

Upon parsing the ML pipeline specification, the profiler 204 generates an ML pipeline plan by determining the ML pipeline, including placement of pipeline operators, and pipeline configuration.

To determine what pipeline to use for a ML pipeline, one embodiment first constructs an initial pipeline, as illustrated at 206, by mapping a user ML pipeline specification to a general template optimized for performance and resource efficiency, and then determines the best ordering of the pipeline operators (including filters and ML models) based on a metric defined to capture the impact of filtering modules on ML pipeline latency and accuracy.

Given a constructed pipeline, one embodiment jointly searches for the best physical topology placement and ML pipeline configuration of operators (as illustrated at 208 and 210 respectively) which, when combined, trends toward the highest utility. To explore placement choices with low cost, one embodiment memoizes intermediate results (i.e., stores intermediate results in a storage device at the pipeline management system 102) from pipeline runs, such that a pipeline with the same configuration only needs to be offline profiled once. For each placement, one embodiment searches for the best ML pipeline configuration by leveraging optimization systems, such as systems implementing Bayesian Optimization, an optimization technique that is useful for exploring a large number of ML pipeline configurations with a small number of trials.

After ML pipeline 212 deployment, one embodiment continues to monitor, as illustrated at 214, ML pipeline 212 performance to detect runtime dynamics. Such dynamics may include, for example, one or more of changes in compute, network, and/or storage resources (such as availability and/or performance), changes in available filters (such as a change in a zoo of filters), changes in available ML models (such as a change in a zoo of ML models), performance criteria changes, changes in input data, etc. In some embodiments, this is performed by the pipeline management system 102 receiving information over a network from various entities. For example, different tiers may send messages to the pipeline management system 102 indicating changes in availability or performance of resources, or changes in data type or quality. A new pipeline specification may be submitted to a user indicating a change in performance criteria or input data. During such events, one embodiment re-profiles the pipeline in a quick and low-cost fashion by leveraging prior knowledge, such as by using memoized data. Thus, embodiments may recursively identify a physical topology of an ML pipeline based on various changes.

In one embodiment, a reference (ground truth) accuracy is determined based on the results of a golden pipeline, where the golden pipeline is the pipeline choice, that based on current knowledge, uses the most expensive configuration.

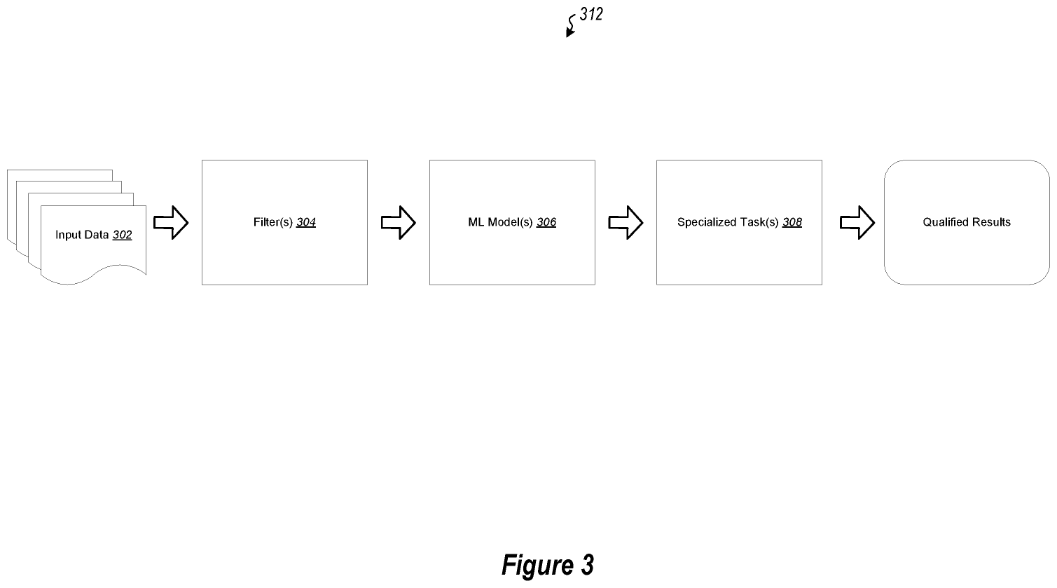

Additional details are now illustrated. Embodiments illustrated herein provide automatic ML pipeline planning for live ML pipelines. A first step is to construct the ML pipeline. This is followed by exploring placement choices and ML pipeline configurations. One embodiment performs pipeline construction by first generating an initial pipeline, and then determining a best ordering of operators for the pipeline to move forward to later profiling stages. Given a user ML pipeline specification, one embodiment generates an initial pipeline using a general template with several types of building blocks as shown in FIG. 3. Starting from the data source providing the input data 302, one embodiment constructs the initial pipeline 312 by inserting filter(s) 304 which reduce the data size or data rate via sampling or filtering techniques, the ML model(s) 306 to perform actual inference task(s), and optional specialized task(s) 308 for additional tasks performed by the ML pipeline 312, which can be performed after the major ML inference task(s) are performed by the ML model(s) 306. Post processing tasks may be, for example, data analysis, data organization and grouping, data filtering, etc.

One embodiment uses a pool of filters for the filters 304 and ML models for the ML models 306 that are readily available, provided by users, operators, or third-party developers and organizations (e.g., public filter zoos and public ML model zoos) to handle user ML pipelines. In some embodiments, which filters and the ML model to use for the ML pipeline is specified by the user in the input ML pipeline specification. Based on the chosen operators (filters and ML models), one embodiment generates a list of configuration knobs for the ML models and filters among which the profiler 204 (see FIG. 2) searches for an optimal set of configurations.

Arranging the building blocks in this way (i.e., with filters before ML models, and potentially before network connections) reduces the amount of data transfer across the edge earlier in the pipeline and leaves operators with higher available computation budget in later pipeline stages, thus implementing an improved and more efficient computer system. This maximizes the savings in both network and compute resources (as well as potentially storage resources) as less data is transmitted and processed across the edge tiers. The design can improve end-to-end ML pipeline latency by reducing the network latency as well as the GPU processing delay with potentially smaller data size for ML inference. Further by strategically placing filters, storage can be reduced overall and/or reduced with respect to more costly storage in terms of type and/or location.

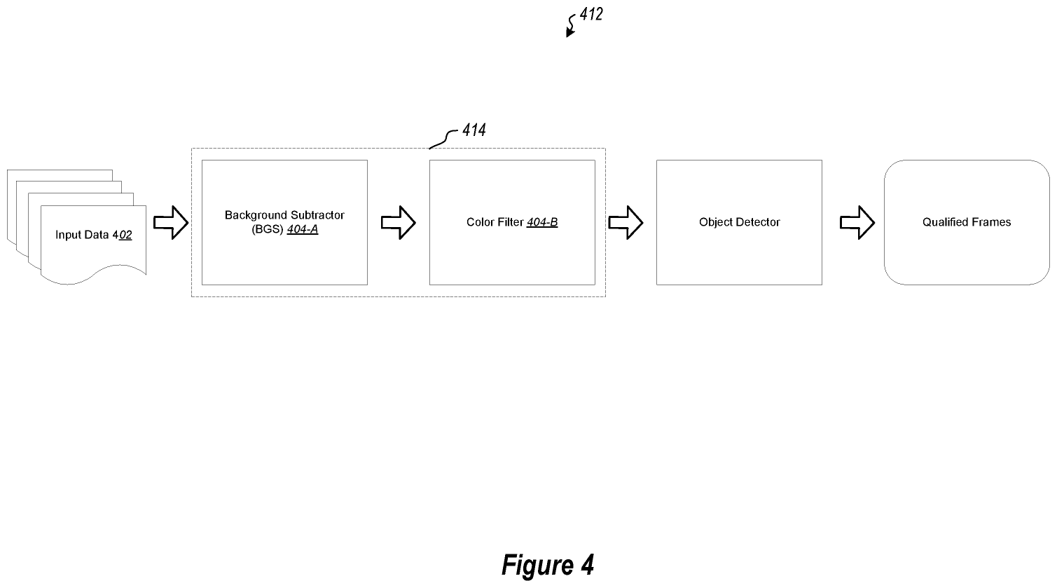

After construction of the initial pipeline, filter placement is determined. Different orderings of filters can lead to different performance characteristics. For example FIG. 4 illustrates a live traffic analysis ML pipeline 412. The ML pipeline 412 applies two filters-a background subtractor (BGS) 404-A to filter frames without motion and a color filter 404-B to detect color within an area of interest. As shown in Table 1, different orderings of the two filters lead to different latency and accuracy profiles. The right pipeline is picked based on each ML pipeline's performance requirements.

TABLE 1

| Order of Filters | Latency (ms) | Accuracy | #GPU Inference |
|---|---|---|---|
| BGS → Color Filter | 2126 | 87.5% | 125 |
| Color Filter → BGS | 1112 | 81.5% | 77 |

The following illustrates details on how some embodiments rank filters with recall and precision. A naïve solution for selecting the filter ordering is to explore pipeline placement and configuration for all possible ordering patterns. However, this solution does not scale well as the number of filters increases. In one embodiment, a new solution is implemented that considers a filter's impact on an ML pipeline's accuracy, latency, and resource consumption by evaluating recall and precision of a filter. In some embodiments, these considerations are done in parallel rather than serially. Recall of a filter is defined as the fraction of samples in input data into a filter that contains the objects of interest (i.e., relevant data) that gets actually passed by the filter (as opposed to filtered out and discarded by the filter). Precision of a filter is the fraction of data samples in output of the filter that contains relevant data. For a given filter, recall may be expected to be relatively high such that it still captures most of the desired data, and ML pipeline accuracy is preserved. A filter with relatively low recall is more apt to drop true positive samples which cannot be recovered later in the pipeline, inasmuch as they have been filtered out and discarded.

Among filters with the same recall, embodiments prefer filters with higher relative precision because these filters provide higher data reduction rates by inasmuch as they pass fewer irrelevant samples. This is desirable because higher reduction of data in general, and in particular reduction of irrelevant data, leads to better ML pipeline latency and resource savings as by eliminating network transportation, GPU processing, and/or data storage for filtered out data.

A metric can be used in some embodiments to evaluate how a given filter affects a ML pipeline plan's utility (U_{q,p,c}). Recall that one embodiment handles ML pipelines with different preferences of latency and accuracy based on the parameter γ in Eq 2. Some embodiments leverage a variation of the F-measure in information retrieval theory to encode this preference in the metric. The F-measure is a measure of a test's accuracy. Denote F_{γ} as the score for a given filter with its precision and recall measurements:

$${F}_{γ} = ( 1 + {β}^{2} ) \frac{precision \times recall}{( {β}^{2} \times precision ) + recall} \qquad ( 4 )$$

where β=γ/(1−γ), and its value captures how many times ML pipeline accuracy is more important than ML pipeline latency.

Embodiments include functionality at the pipeline management system 102 for sorting filters. Measuring F_{γ} gives an indication of how well a single filter fits into an ML pipeline's optimal ML pipeline plan. However, there are still at least two challenges. First, directly applying F_{γ} in sorting filters does not work well as the recall of a filter can change based on a preceding filter. Second, filters may have their own configuration knob that leads to different precision or recall measurements. Applying one set of configuration for all filters might oversimplify the problem with inaccurate estimation, whereas evaluating too many configuration sets increases profiling cost.

One embodiment for evaluating multiple filters treats a sequence of filters as a bulk filter with input being the input data 302 and the output of the bulk filter being the output from the last filter. For example, FIG. 4 illustrates a bulk filter 414. The input data to the bulk filter 414 is the input data 402, and the output data from the bulk filter 414 is data from the color filter 404-B.

Overall F_{γ} is measured using representative data for each permutation of the available filters. To handle filters with various different configurations, representative configuration settings are selected to capture the effect of configuration knobs on filters, where for each configuration setting, each of the filters are configured at selected x-th percentile in the range of their configuration knob. Filters with no configurable parameters remain unchanged.

For example, in one embodiment, filter configuration settings for x=20%, 50%, and 80% are used for evaluating pipelines permutations, which results in (3×total number of filter ordering) F_{γ} values to collect. One embodiment then selects the ordering that achieves the highest F_{γ} to complete the pipeline construction process.

After the ML pipeline is constructed, the next step is to determine how to place each of the pipeline operators across the edge infrastructure. Rule-based solutions are good at reducing search space but may fail to explore all promising placement choices. However, exhaustively searching through all possible placements requires high search cost during profiling while deploying the ML pipeline across the edge. One embodiment combines the benefits of the two approaches by still exploring all feasible placement choices while reducing search cost by memoizing intermediate results from pipeline runs.

When considering pipeline placement choices, some embodiments operate under two assumptions. First, embodiments assume homogeneous compute resources within the same infrastructure tier. For example, embodiments may assume that GPUs in the same tier have the same performance when processing ML pipelines. Second, intra-communication cost within the same tier can be ignored and the network latency component is dominated by the time spent going across different edge tiers.

The idea of memoizing pipeline results is based on two characteristics of live ML pipelines. First, ML pipeline accuracy does not depend on the placement choices given a pipeline with the same pipeline configuration. Second, ML pipeline latency and resource consumption are affected by placement choices due to additional network latency, network bandwidth consumption, and GPU processing time. These two characteristics allow the pipeline to be deployed offline in an infrastructure only once per pipeline configuration during the profiling stage, and the ability to accurately reuse the results to evaluate a new placement choice by calculating additional latency and resource components introduced by the placement, while reusing the same ML pipeline accuracy measurement. Given a total of M placement choices and N combinations of pipeline configurations, embodiments illustrated herein improve the search complexity from O(MN) to O(N) for a given pipeline.

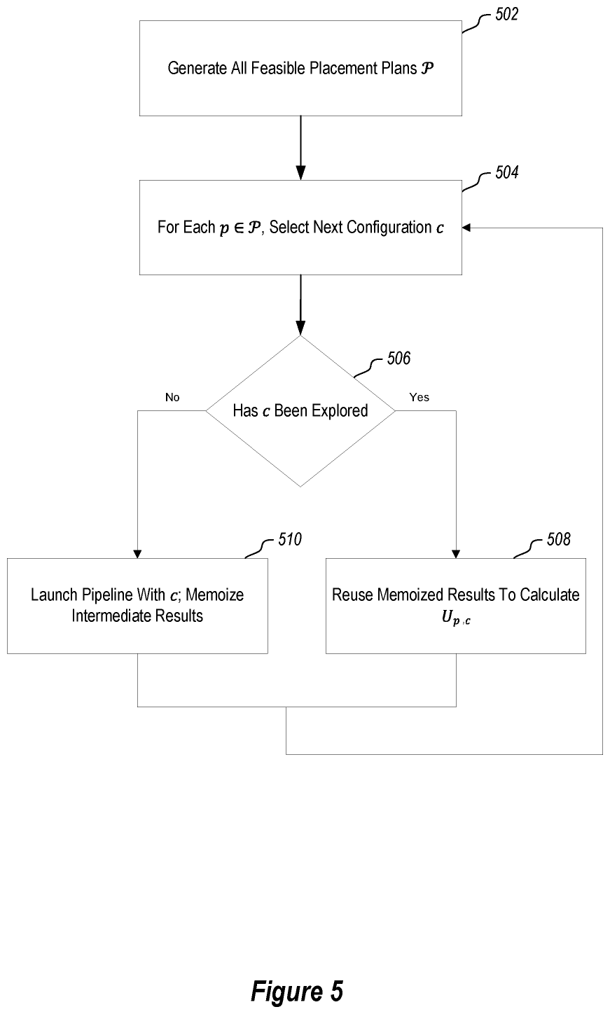

FIG. 5 describes a high-level flow of how one embodiment evaluates placement choices. Given a pipeline, one embodiment begins, as illustrated at 502, with generating a collection of all feasible placement plans. Infeasible plans where operators are placed in a different order than they appear in the pipeline (e.g., placing the ML model in front of the filters) are excluded from the collection. For each placement choice, as illustrated at 504, one embodiment explores promising ML pipeline configurations to evaluate the utility of the ML pipeline configurations. For every new, unexplored set of pipeline configurations, the embodiment launches the pipeline across a heterogeneous edge infrastructure. In this case, one embodiment not only collects ML pipeline performance and resource consumption for utility calculation but also memoizes intermediate results from each pipeline operator, including the operator's output size, output bandwidth, and data processing time (e.g., time spent in a filtering module or GPU inference time). Some embodiments also collect size and bandwidth of the data source to account for the case where only the data source is placed on the first tier, i.e., the tier including the device edge 104 (see FIG. 1). At 506, a decision is made. If a chosen pipeline placement and configuration has not been explored, the pipeline is launched across the heterogeneous edge infrastructure as illustrated at 510. If a chosen pipeline configuration c has been explored by a previous placement choice, one embodiment calculates the utility for the new placement p by estimating the new ML pipeline end-to-end latency L_{p,c} and resource consumption R_{p,c} without launching the pipeline, using previously explored configurations, as illustrated at 508. L_{p,c} is estimated by summing up the total processing time of each operator measured offline excluding the ML model, the additional network latency introduced by placement, and the updated GPU inference latency as shown below:

$${L}_{p , c} = {L}_{offline , total} - {L}_{offline , gpu} + \sum {L}_{p , net} + {L}_{p , gpu} \qquad ( 5 )$$

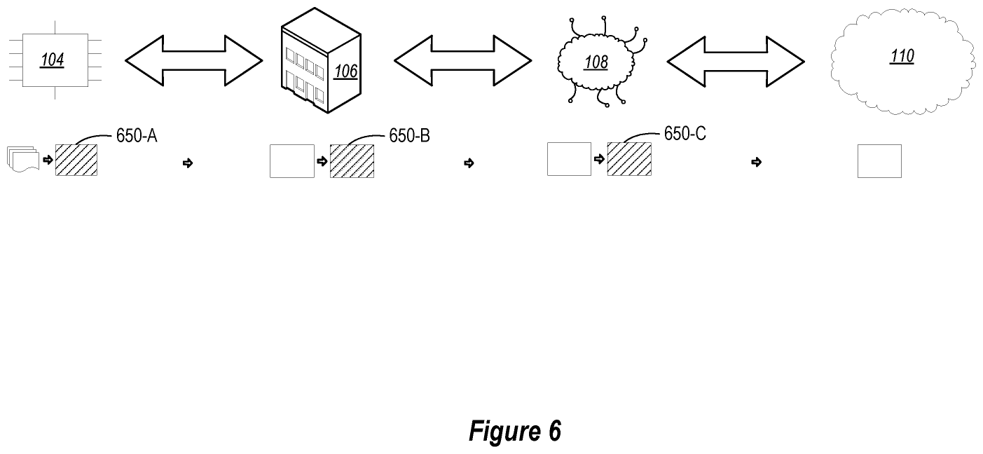

The network component of the new latency, ΣL_{p,net} is calculated by summing up the network latency going across two adjacent tiers. Network latency within a given tier can be excluded in some embodiments, as it is significantly (e.g., at least an order of magnitude) smaller that inter-tier latency. FIG. 6 illustrates an example for a pipeline with six operators placed across the edge infrastructure including the device edge 104, the on-premise edge 106, the public MEC 108, and the cloud datacenter 110. Output sizes of shaded operators 650-A, 650-B, and 650-C are used to calculate the additional latency introduced by the placement.

The latency is calculated by taking the ratio of an operator's output size (cached per configuration) to the assigned link bandwidth capacity the ML pipeline data traverses through. Note that in some embodiments, only the operators sending data to the next tier in the infrastructure are considered. The GPU inference latency, L_{gpu}, is updated by multiplying with a coefficient based on the GPU type to reflect the performance difference. This may be determined by profiling all GPUs available in a cluster where the ML pipeline is deployed. R_{p,c} is estimated in a similar way by including the network bandwidth and GPU processing time introduced by the placement.

For each placement choice, one embodiment leverages optimization processes, such as Bayesian Optimization. This can be done to efficiently explore ML pipeline configurations. Bayesian Optimization is a methodology for optimizing expensive objective functions whose closed-form expressions are not revealed (i.e., black-box functions).

At a high level, given a black-box objective function, Bayesian optimization learns the shape of the function one step at a time by observing its output based on the input (e.g., an N-dimensional array) suggested by Bayesian optimization. After each iteration, Bayesian optimization picks the next input that it thinks has the highest probability of reaching the global maximum of the objective function. The more observations Bayesian Optimization accumulates, the more confidence it gains regarding the actual shape of the objective function. Therefore, Bayesian Optimization is known for quickly finding the input that maximizes an objective function in a small number of iterations.

Internally, Bayesian Optimization learns an objective function by leveraging a prior function and an acquisition function. A prior function represents the belief about the space of possible objective functions. It is combined with accumulated observations to obtain a posterior distribution which captures the updated belief about the objective function. On the other hand, the acquisition function guides Bayesian Optimization to choose the next promising input where the value of acquisition function is maximized.

Embodiments may use optimization, and in particular Bayesian Optimization in some examples, to tune the entire set of input configurations all together for each iteration no matter how large the input vector is. Other optimizations may alternatively be used, such as Multi-Armed Bandit, which adjusts one configuration knob at a time. Optimizations such as Bayesian Optimization may include flexibility of learning objective functions with unknown closed-form expressions to allow embodiments to handle a wide range of ML applications without redesign.

The following illustrates an example of applying Bayesian Optimization to a pipeline configuration. The objective function that Bayesian Optimization tries to evaluate is defined as f(\vec{x}), which models how optimal a given ML pipeline plan is based on a given pipeline and a physical placement choice. The input (\vec{x}) is the set of ML pipeline configuration knobs, and the output of f is the utility value, U_{q,p,c} for a given pipeline q with placement p and a set of configuration c. For each iteration, one embodiment launches the pipeline with the configurations suggested by Bayesian Optimization (i.e., (\vec{x}), and collects the measurements to compute U_{q,p,c}, which is then fed back to Bayesian Optimization as the new observation.

Some embodiments use Gaussian Process Regression as the prior function and use Matern 5/2 as its covariance function to describe the smoothness of the prior distribution. There are three major approaches used in acquisition functions, namely probability of improvement (PI), expected improvement (EI), and upper confidence bound (UCB).

Some embodiments start with N random sets of input ML pipeline configurations as initial observations for Bayesian Optimization to learn the rough shape of the objective function. In some embodiments, N=3, as it has been shown in experiments to work well for various workload settings. However, in other embodiments, other values of N may be selected. One embodiment stops Bayesian Optimization when the improvement of the utility value is less than a threshold for a few consecutive runs (e.g., 10% for 5 consecutive runs). Embodiments may include a sensitivity analysis on how the parameters used in the starting and stopping conditions affect Bayesian Optimization's performance.

After deploying the ML pipeline onto the edge, embodiments may perform online adaptation to handle any runtime dynamics. This can result in embodiments quickly converging back to a good ML pipeline plan with a low profiling cost. To this end, one embodiment leverages two design principles during its online phase: (i) reprofile the ML pipeline when runtime dynamics happen, and (ii) leverage prior knowledge during reprofiling.

Changes in runtime dynamics may include, for example, at least one of available compute, network or, storage changing, at least one of a zoo of filters having the plurality of filters changing or a zoo of ML models having the one or more specific ML models changing, at least one of changes in input data type, input data bit rate, or input data quality, etc.

One embodiment detects run time dynamics by monitoring the change in a ML pipeline's utility values. To keep track of utility changes, one embodiment obtains the ground truth reference to determine the real-time query accuracy, as live data are not labelled. To achieve this, one embodiment launches a duplicated pipeline with the most expensive configuration inside a cloud datacenter. The duplicated pipeline takes the ML pipeline's live data as input, which are periodically transmitted from the edge to the cloud datacenter to minimize network cost. One embodiment collects the measurements needed to compute the utility (i.e., end-to-end latency, ML pipeline outputs, and resource consumption) using the deployed pipeline. A substantial change in the utility triggers reprofiling which deploys the ML pipeline in the cloud datacenter as the case of offline profiling. Embodiments can set the threshold of utility change (e.g., 10% in one example implementation) empirically via profiling.

Reprofiling can be implemented to take advantage of prior knowledge from offline profiling processes. This can be done inasmuch as significant parts of the ML pipeline, such as the object of interest and where the ML pipeline implementation takes place, remains the same when runtime dynamics happens. Consider a camera example where example scenes taken by the same camera during different times of the day from a ML pipeline that detects red vehicles. A high level of similarity may exist between the two scenes except for the change of environment illumination. The distance between two configurations, CA and CB, is the total number of steps needed for each configuration knob in CA to reach the configuration in CB. In one specific tested example, applying the same configuration in daytime to nighttime scenes leads to an average 26.2% utility drop among all placement choices, but it requires only an average distance of 2.47 steps to converge back to the ML pipeline plan with highest utility.

To apply prior knowledge, one embodiment applies the following changes to the normal profiling process. First, the embodiment keeps the constructed pipeline from offline profiling fixed and skips the pipeline selection phase, as the pipeline determined offline remains effective during runtime dynamics. Second, one embodiment keeps track of the most recent top-K and worst-K configuration per placement choices (K=3), and applies those as initial data points to launch the Bayesian Optimization process for each remaining placement choice, such that Bayesian Optimization can quickly grasp for basic shape of the objective function.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

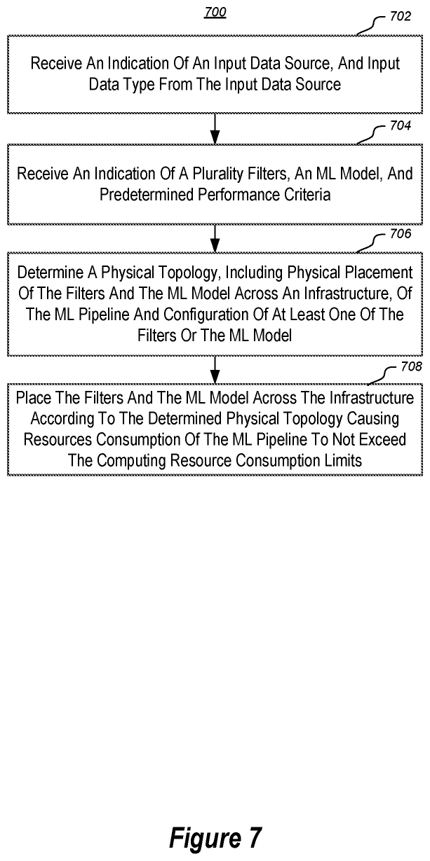

Referring now to FIG. 7, a method 700 is illustrated. The method 700 may be practiced at an ML pipeline management system, such as the ML pipeline management system 102 illustrated in FIG. 1. The method 700 includes acts for optimizing deployment of an ML pipeline, wherein the ML pipeline includes operators to perform specific ML task. The method 700 includes receiving an indication of an input data source, and input data type from the input data source (act 702). For example, the user could input a specification such as the specification illustrated above into computing systems included in the ML pipeline management system 102.

The method 700 further includes receiving an indication of a plurality filters and predetermined performance criteria identifying computing resource consumption limits (act 704). The filters in the plurality of filters include filter operators that operate on input data from the input data source to reduce input data size by sampling data or filtering out data. In some embodiments, the filters may be identified specifically by the user, such as in the ML pipeline specification. Thus, filters could be identified specifically by a unique identifier. Alternatively, filters could be identified by reference to a zoo of filters, either by the zoo being referenced by a user or simply as a result of the ML pipeline management system having knowledge of the filter zoo. Similarly, specific ML models could be identified by unique identifiers in the ML pipeline specification. Alternatively, ML models could be identified by identifying a model with certain characteristics from an ML model zoo. The predetermined performance criteria may include factors related to latency, accuracy, cost (e.g., cost of compute, storage, and/or network). The performance criteria is typically a combination of criteria, such as a ratio including latency and accuracy, but other operations on criteria, such as addition and/or subtraction could be implemented. Note that in some embodiments, output and output type may be specified.

The method 700 further includes determining a physical topology, including physical placement of the filters and the ML model across an infrastructure, of the ML pipeline and configuration of at least one of the filters or the ML model. Determining is performed in a fashion such that placement of the filters, placement of the ML model, and the configuration satisfy the performance criteria. Determining is performed based on a plurality of configurations of operators in the operators being provided as input. (act 706). The physical topology includes a plurality of tiers connected through network connections to each other. Tiers in the plurality of tiers are collections of computing resources. The different tiers have different geographic boundaries, different compute latencies, and different network throughputs from each other. In some embodiments, an optimizer, such as a Bayesian Optimizer may be implemented by the ML pipeline management system 102 for performing Bayesian optimization as illustrated above to determine the physical topology.

The method 700 further includes placing the filters and the ML model across the infrastructure according to the determined physical topology causing resources consumption of the ML pipeline to not exceed the computing resource consumption limits when the filters and the ML model are performing the specific ML tasks. (act 708).

The method 700 may further include ranking the filters, using recall and precision. In this example, determining the physical topology of the ML pipeline and configuration is performed as a result of the ranking.

The method 700 may be practiced where receiving an indication of the plurality filters to be included in the ML pipeline, the ML model, and the predetermined performance criteria comprises receiving information identifying the plurality filters, the one or more specific ML models of the one or more model types, and the predetermined performance criteria from the ML pipeline specification.

The method 700 may be practiced where determining the physical topology of the ML pipeline and configurations is performed using memoized intermediate results from previous ML pipeline runs.

The method 700 may be practiced where the performance criteria comprises a ratio of accuracy and latency.

The method 700 may be practiced where the performance criteria comprises a latency factor. The latency factor comprises a network latency component that is computed by summing network latency across adjacent tiers while excluding latency within tiers.

The method 700 may be practiced where the performance criteria is based on a quality of service tier of the ML pipeline. For example, subscriptions to certain services and quality of service agreements may determine ML pipeline performance requirements.

The method 700 may further include recursively performing the act of determining the physical topology of the ML pipeline and configuration, as a result of at least one of available compute, network and/or, storage changing.

The method 700 may further include recursively performing the act of determining the physical topology of the ML pipeline and configuration, at a result of at least one of a zoo of filters having the plurality of filters changing or a zoo of ML models having the ML model changing.

The method 700 may further include recursively performing the act of determining the physical topology of the ML pipeline and configuration, as a result of the performance criteria changing.

The method 700 may further include recursively performing the act of determining the physical topology of the ML pipeline and configuration, as a result of the input data changing as a result of at least one of changes in input data type, input data bit rate, or input data quality.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. At an ML pipeline management system, a method of optimizing deployment of an ML pipeline, wherein the ML pipeline includes operators to perform specific ML tasks, the method comprising:
receiving an indication of an input data source, and input data type from the input data source;
receiving an indication of a plurality filters, the filters in the plurality of filters comprising filter operators that operate on input data from the input data source to reduce input data size by sampling data or filtering out data, an ML model, and predetermined performance criteria identifying computing resource consumption limits;
determining based on a plurality of configurations of operators in the operators as input, a physical topology, including physical placement of the filters and the ML model across an infrastructure, of the ML pipeline and configuration of at least one of the filters or the ML model, such that placement of the filters, placement of the ML model, and the configuration satisfy the performance criteria; and
placing the filters and the ML model across the infrastructure, comprising a plurality of tiers connected through network connections to each other, different tiers in the plurality of tiers being collections of computing resources, the different tiers having different geographic boundaries, different compute latencies, and different network throughputs from each other, according to the determined physical topology causing resources consumption of the ML pipeline to not exceed the computing resource consumption limits when the filters and the ML model are performing the specific ML tasks.

2. The method of claim 1, further comprising ranking the filters, using recall and precision, and wherein determining the physical topology of the ML pipeline and configuration is performed as a result of ranking.

3. The method of claim 1, wherein receiving an indication of the plurality filters to be included in the ML pipeline, the ML model, and the predetermined performance criteria comprises receiving information identifying the plurality filters, the ML model, and the predetermined performance criteria from an ML pipeline specification.

4. The method of claim 1, wherein determining the physical topology of the ML pipeline and configuration is performed using memoized intermediate results from previous ML pipeline runs.

5. The method of claim 1, wherein the performance criteria comprises a ratio of accuracy and latency.

6. The method of claim 1, wherein the performance criteria comprises a latency factor, and wherein the latency factor comprises a network latency component that is computed by summing network latency across adjacent tiers while excluding latency within tiers.

7. The method of claim 1, wherein the performance criteria is based on a quality of service tier of the ML pipeline.

8. The method of claim 1, further comprising recursively performing the act of determining the physical topology of the ML pipeline and configuration, as a result of at least one of available compute, network or, storage changing.

9. The method of claim 1, further comprising recursively performing the act of determining the physical topology of the ML pipeline and configuration, as a result of at least one of a zoo of filters having the plurality of filters changing or a zoo of ML models having the ML model changing.

10. The method of claim 1, further comprising recursively performing the act of determining the physical topology of the ML pipeline and configuration as a result of the performance criteria changing.

11. The method of claim 1, further comprising recursively performing the act of determining the physical topology of the ML pipeline and configuration, as a result of the input data changing as a result of at least one of changes in input data type, input data bit rate, or input data quality.

12. At an ML pipeline management system, a method of optimizing deployment of a ML pipeline, wherein the pipeline includes operators to perform specific ML tasks, the method comprising:
generating a set of feasible placement plans for placing the ML pipeline across an infrastructure comprising a plurality of tiers connected through network connections to each other, different tiers in the plurality of tiers being collections of computing resources, the different tiers having different geographic boundaries, different compute latencies, and different network throughputs from each other, each placement plan in the set of placement plans comprising placement of a plurality of filters and placement of an ML model across the infrastructure;
generating a plurality of configurations of operators in the operators for the plurality of placement plans;
iteratively determining placement plans and configurations that have not been explored, launching unexplored placement plans and unexplored configurations across the infrastructure, and memoizing latency results for the launched placement plans and launched configuration;
iteratively determining memoized latency results of previously explored placement plans and previously explored configurations;
using memoized latency results of the launched placement plans and launched configuration, and the previously explored placement plans and previously explored configurations to determine a selected placement plan and a selected configuration without deploying the previously explored placement plans and previously explored configurations across the infrastructure; and
as a result, deploying the ML pipeline across the infrastructure according to the selected placement plan and selected configuration.

13. The method of claim 12, further comprising ranking filters in the plurality of filters, using recall and precision.

14. The method of claim 12, wherein selecting the selected placement plan and the selected configuration comprises using a ratio of accuracy and latency to determine which placement plan and configuration to select.

15. The method of claim 12, wherein selecting the selected placement plan and the selected configuration comprises using a latency factor, and wherein the latency factor comprises a network latency component that is computed by summing network latency across adjacent tiers while excluding latency within tiers.

16. The method of claim 12, further comprising generating new placement plans as a result of at least one of available compute, network or, storage changing.

17. The method of claim 12, further comprising generating new placement plans as a result of at least one of a zoo of filters having the plurality of filters changing or a zoo of ML models having the one or more ML models changing.

18. The method of claim 12, further comprising generating new placement plans as a result of ML pipeline input data changing as a result of at least one of changes in input data type, input data bit rate, or input data quality.

19. A computing system comprising:
one or more processors; and
one or more computer-readable media having stored thereon instructions that are executable by the one or more processors to configure the computer system to optimize deployment of an ML pipeline, wherein the ML pipeline includes operators to perform specific ML tasks, including instructions that are executable to configure the computer system to perform at least the following:
receive an indication of an input data source, and input data type from the input data source;
receive an indication of a plurality filters, the filters in the plurality of filters comprising filter operators that operate on input data from the input data source to reduce input data size by sampling data or filtering out data, an ML model, and predetermined performance criteria identifying computing resource consumption limits;
determine based on a plurality of configurations of operators in the operators as input, a physical topology, including physical placement of the filters and the ML model across an infrastructure, of the ML pipeline and configuration of at least one of the filters or the ML model, such that placement of the filters, placement of the ML model, and the configuration satisfy the performance criteria; and
place the filters and the ML model across the infrastructure, comprising a plurality of tiers connected through network connections to each other, different tiers in the plurality of tiers being collections of computing resources, the different tiers having different geographic boundaries, different compute latencies, and different network throughputs from each other, according to the determined physical topology causing resources consumption of the ML pipeline to not exceed the computing resource consumption limits when the filters and the ML model are performing the specific ML tasks.

20. The computing system of claim 19, wherein determining a physical topology of the ML pipeline and configurations is performed using memoized intermediate results from previous ML pipeline runs.
